(19) United States
(12) Patent Application Publication
(10) Pub. No.: US 2006/0281051 A1
(43) Pub. Date: Dec. 14, 2006

(54) Method for producing a dental prosthesis and artificial tooth therefor

(75) Inventors: Martin Koller, Dannau (DE); Frank Becker, Lutjenburg (DE)

Correspondence Address: MORRISON & FOERSTER LLP, 1650 TYSONS BOULEVARD, SUITE 300, MCLEAN, VA, 22102, US

(73) Assignee: Merz Dental GmbH, Lutjenberg (DE)

(21) Appl. No.: 10/548,108

(22) PCT Filed: Mar. 4, 2004
(86) PCT No.: PCT/EP04/02217

§ 371 Date: Aug. 7, 2006

(30) Foreign Application Priority Data
Mar. 4, 2003 (EP) 03004741.9

(51) Int. Cl. A61C 13/08

(52) U.S. Cl. 433/198

(57) ABSTRACT

A process for producing a dental prosthesis includes producing a wax prosthesis including artificial teeth and a receiving bed for articulating the artificial teeth by inserting the artificial teeth into the receiving bed at anatomically correct positions, producing a negative mold of the wax prosthesis using a duplicating medium, removing the receiving bed, introducing a fixing material into the negative mold, and allowing the fixing material to set, so that the undersides of the artificial teeth are permanently embedded in the fixing material. The artificial teeth have a holding groove running in a mesio-distal direction on its underside, so as to produce reliable positively locking joining of the artificial tooth to the receiving bed of the wax prosthesis.

The invention relates to a process for producing a dental prosthesis and to an artificial tooth therefor having a top side, designed as a biting surface, and an underside, which is designed for insertion into a receiving bed of the dental prosthesis.

Dental prostheses usually comprise a receiving bed and a plurality of artificial teeth inserted into it. One difficulty is that of positioning the artificial teeth at the correct position in the receiving bed and securely holding them in that position. The receiving bed usually consists of a wax-like material. This enables the artificial teeth to be pressed into the receiving bed as they are inserted, with the wax being displaced back on account of its plasticity, making space for the artificial tooth. The plasticity of the wax holds the artificial tooth in place. The reliability of accurate positioning of the artificial tooth depends to a considerable extent on the configuration of the underside of the artificial tooth. If the underside is of planar configuration, accurate positioning is relatively simple. However, for strength or anatomy reasons, the underside of the artificial tooth is often not of planar design, but rather has inclined surfaces. The inclined surfaces lead to the artificial teeth undesirably moving transversely with respect to the direction of the inclined surfaces when compressive forces are applied. This means that accurate positioning can be achieved only with difficulty.

Incorrect positioning in the wax bed has an immediate adverse effect on the positional accuracy of the final dental restoration, since the tooth which has slipped in the wax material is accordingly held at the incorrect position during further processing in the known front wall technique, and also remains at this incorrect position when the wax material is melted off and in a subsequent step replaced by the fixing material of the final tooth restoration. Consequently, the final tooth restoration permanently has the defect caused by the incorrect positioning in the wax bed.

Artificial teeth which have an opening on their underside for securing them in the final tooth restoration are known from the prior art in a different context, namely in connection with tooth restorations for definitive supply. A metallic reinforcing element secured in the fixing material of the final tooth restoration engages in the undercut opening and thereby secures the tooth in the fixing material (U.S. Pat. No. 2,600,496, U.S. Pat. No. 200,284). Furthermore, a final tooth restoration in which the artificial tooth comprises a composite made up of a metallic support and a ceramic body is also known. The fixing material is rubber or cellulite material, into which the tooth is permanently inserted. To ensure sufficient reliability of bonding, it is also necessary to use a separate intermediate material, which has a low melting point, is introduced at one end of a row of teeth by means of an overflow groove and flows onward from tooth to tooth via this groove (U.S. Pat. No. 628,345)

It is also known to produce retention grooves on the underside of the artificial tooth by means of a special milling cutter (DE-U-85,13,665). The groove produced by means of this milling cutter has extraordinarily small dimensions, which are filled only by very liquid fixing material. Wax material can only penetrate into these small grooves with difficulty, or cannot do so at all.

The invention is based on the object of providing a production process and an artificial tooth allowing simpler and more accurate positioning of the artificial tooth.

The invention achieves the object by means of the features of the independent claims. Advantageous refinements form the subject matter of the dependent claims.

According to the invention, in a process for producing a dental prosthesis, comprising the steps of producing a wax prosthesis comprising artificial teeth and a receiving bed for articulating the artificial teeth by inserting the artificial teeth into the receiving bed at the anatomically correct position, producing a negative mold of the wax prosthesis by means of a duplicating medium which is designed to receive the artificial teeth in such a way that they maintain their position, removing the receiving bed, introducing a fixing material into the negative mold, causing the fixing material to set, so that the lower part of the artificial teeth is permanently embedded in the fixing material, it is provided that artificial teeth which on their underside have a holding groove running in the mesio-distal direction are used.

The inventive configuration of the underside produces unambiguous and stable positioning and fixing of the tooth in the receiving bed. The tooth is better secured with respect to displacement, in particular in the buccolabial direction or the opposite direction to the buccolabial direction. Usually, the underside of the artificial teeth is not perpendicular with respect to a mastication force acting from above, but rather is inclined outward toward the buccolabial side. Since the underside therefore forms a “skew plane”, a buccolabially directed lateral force is produced under the action of the mastication force, seeking to displace the tooth in the horizontal direction. The holding groove according to the invention secures the artificial tooth with respect to undersirable displacement of this type. The risk of the artificial tooth shifting under the action of the mastication force during the wax try-in of the dental prosthesis on the patient is thereby effectively counteracted. This configuration according to the invention ensures that the artificial teeth, during removal of the prosthesis after the try-in, are at their anatomically correct position, specifically even if the prosthesis has been exposed to high mastication forces. This high positional accuracy is a precondition for it being possible for the artificial teeth to be held in the correct position by the duplicating medium and therefore retaining their anatomically correct position even when the receiving bed is removed and the final fixing material, in which the underside of the artificial teeth is embedded, is introduced instead.

The core concept of the invention is that of substantially protecting the artificial teeth from undesirable twisting in the receiving bed. The overall result, therefore, is both simplified insertion of the artificial tooth into the receiving bed and substantially secure holding of the inserted tooth in the bed. This increases the dimensional accuracy of the prosthesis overall both before, during and after the wax try-in. Furthermore, the groove according to the invention also simplifies positionally accurate reinsertion of the tooth when the latter has broken out during the try-in. Consequently, the invention creates the foundation for the production of a tooth restoration during subsequent further processing in which the artificial teeth are located at the anatomically correct position with a high degree of accuracy. The invention is based on the discovery that although in the production processes customarily used the steps of producing the negative mold and introducing the fixing agent took place with a high degree of accuracy, undesirable displacements of the artificial tooth in the receiving bed occurred during the initial wax try-in, in particular on account of mastication forces which occur when trying the bite. These errors have then continued without correction through the further processing, so that the tooth restoration ultimately produced was correspondingly defective. The benefit of the invention is that it prevents this from happening.

The invention also encompasses a corresponding artificial tooth for dental prostheses, having a top side, designed as a biting surface, and an underside for insertion into a receiving bed of the dental prosthesis, with at least one holding groove, which runs in the mesio-distal direction, being formed on the underside of the artificial tooth.

The artificial tooth according to the invention may be designed both as a posterior tooth and as an anterior tooth. Depending on which of these options is selected, the biting surface is of areal extent for mastication or pointed for biting off.

It is expedient for a displacement space to be formed on the underside by an encircling rim in which the holding groove is formed. The rim improves the positional accuracy of the tooth in the tooth bed and during insertion displaces wax into the displacement space which it surrounds. In the inserted state, the displacement space is therefore substantially filled with wax. This, in combination with the groove according to the invention formed in the rim, provides even better positional accuracy of the tooth in the receiving bed. In this context, it is preferable for the groove to be formed exclusively in the protruding rim. This ensures that the rim is filled with wax during insertion of the artificial tooth into the receiving bed, so that the securing function is performed. However, the possibility of the groove extending beyond the region of the protruding rim into the underside should not be ruled out. This may be advantageous in particular if the tooth is exposed to relatively high loads and is therefore to be inserted deep into the receiving bed.

To avoid load peaks, it is preferable for the transition between the underside and the groove to be rounded. This shaping ensures that sufficient wax material penetrates into the groove during insertion of the artificial tooth into the receiving bed, specifically without the risk of the formation of cracks as a result of load concentrations in the corner region.

In one expedient embodiment, the groove is semicircular in cross section. This cross-sectional shape is economical to produce, and, on account of its internally round configuration, avoids the occurrence of load peaks. Weakening of the structure of the artificial tooth can be avoided in this way. However, as an alternative it is also possible to provide other cross-sectional shapes. By way of example, the groove may also be rectangular in cross section. On account of its steep flanks, this has the advantage of offering particularly high security against displacement and twisting. The occurrence of undesirable load peaks is substantially prevented by rounding the corners.

In one tried-and-tested embodiment, at least one further holding groove is arranged parallel. This makes it possible to form a multiple groove which contributes to a further increase in the reliability of securing.

Depending on whether it is configured as a posterior tooth or as an anterior tooth, the top side of the artificial tooth according to the invention is of areal extent or more pointed. The holding groove is preferably arranged in such a way below the top side that it is located vertically below the surface center of gravity of the top side. In this context, the direction of the vertical is-defined by the direction of the mastication force which is to be applied by the tooth. This arrangement is achieved by virtue of the fact that the artificial tooth does not tilt out of position even under large mastication forces, which could cause the holding groove to lose contact with the receiving bed. Consequently, the artificial tooth according to the invention is held securely in the receiving bed even under high loads.

The invention is explained in more detail below with reference to the drawing, which illustrates advantageous exemplary embodiments and in which:

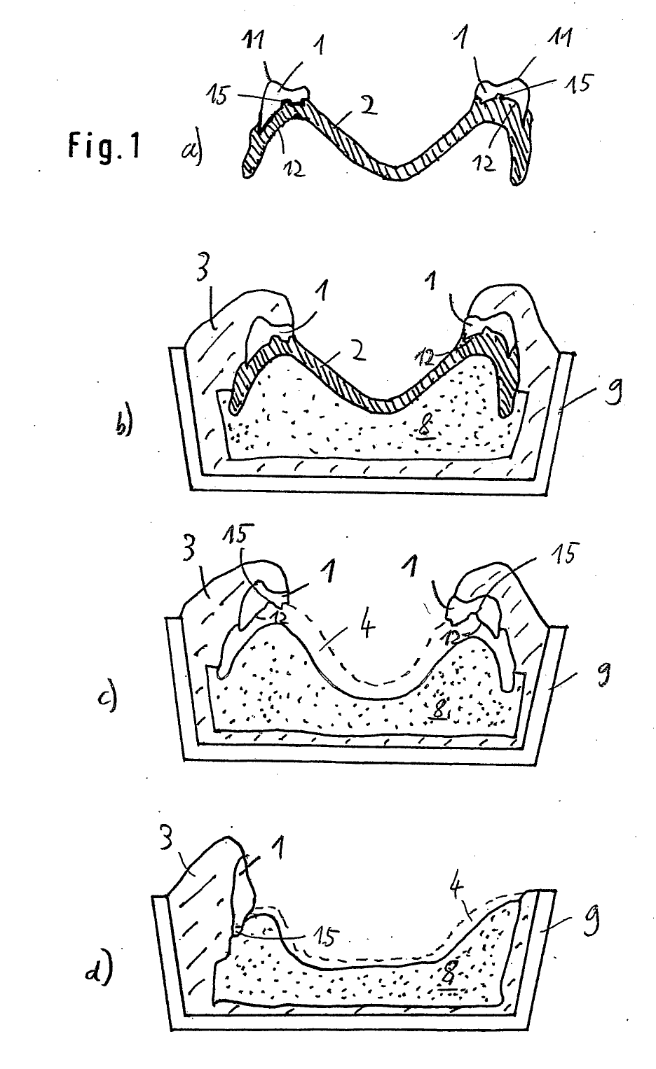

FIG. 1 shows cross-sectional illustrations of various stages involved in the production of a dental prosthesis according to the invention;

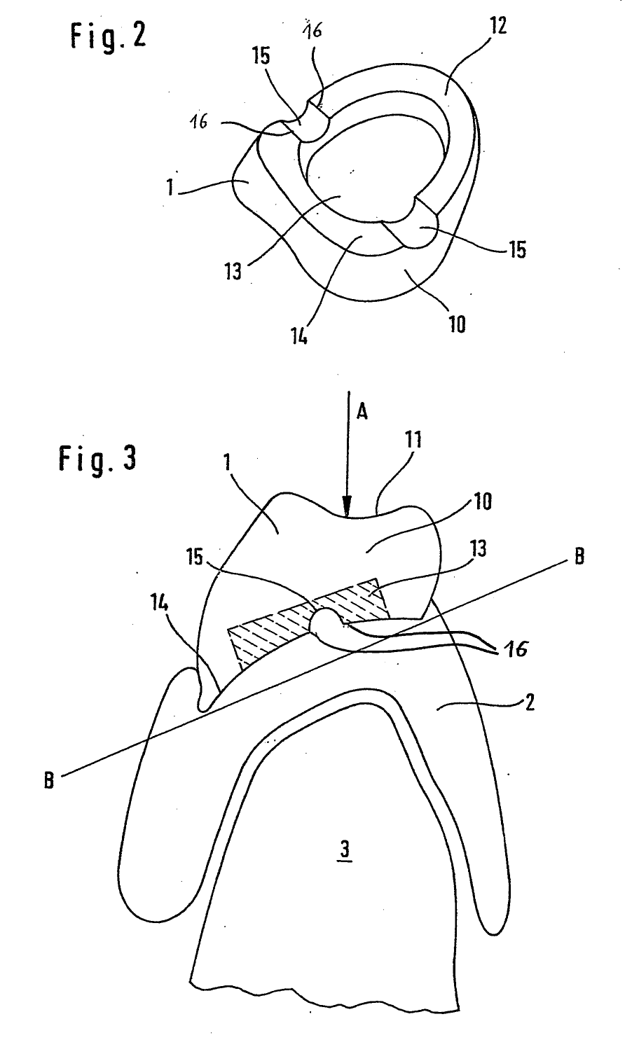

FIG. 2 shows a perspective view of a first exemplary embodiment of an artificial tooth according to the invention obliquely from below;

FIG. 3 shows a section through a dental prosthesis into which the artificial tooth according to the invention shown in FIG. 1 has been inserted; and

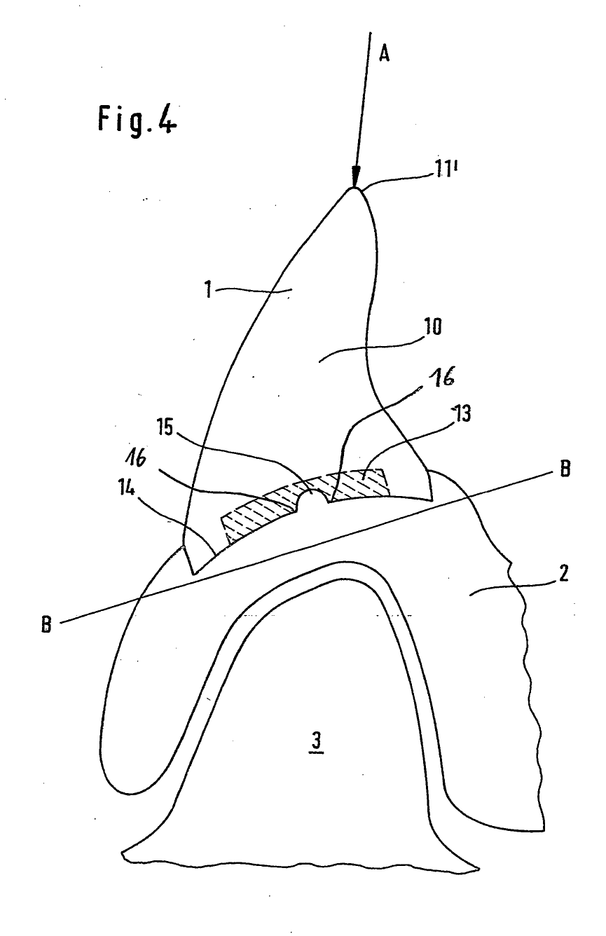

FIG. 4 shows a section through a dental prosthesis into which an artificial tooth in accordance with a second exemplary embodiment has been inserted.

An artificial tooth, which is denoted overall by reference numeral 1, has a top side 11, an underside 12 and a plurality of side faces. The artificial tooth 1 is made from a strong and biocompatible material, for example polymethly methacrylate (PMMA). However, it is also possible to use other materials suitable for use as an artificial tooth, in particular nonmetals, such as for example ceramic or the like, but also metals, such as gold or the like.

On its underside 12, the artificial tooth 1 has an encircling rim 14. This bounds a displacement space 13, which in the exemplary embodiment illustrated is completely enclosed by the encircling rim 14. The displacement space 13 has a flat base. It, together with the surface of the rim 14, forms the underside 12 of the artificial tooth 1. The underside 12 is inclined with respect to the top side 11, so that the height of the tooth increases in the buccolabial direction. This results in a “skew plane” on the underside 12 of the artificial tooth 1. This is represented as line B-B in FIG. 3.

A holding groove 15 is formed in the rim 14. In the exemplary embodiment illustrated, the holding groove 15 is semicircular in cross section. The diameter of the holding groove 15 is such that it does not intersect the base of the displacement space 13 even at its lowest point. In the exemplary embodiment illustrated, the ratio between the diameter of the holding groove 15 and the height of the rim 14 is approximately two to three. In the exemplary embodiment illustrated, the two semicircular recesses of the holding groove are arranged aligned in the rim 14. This is an advantageous arrangement from a production engineering perspective; however, it is not imperative, and it is also possible for the holding grooves 15 to be arranged offset with respect to one another. The transition region 16 between the holding groove 15 and the surface of the rim 14 is rounded. This has the advantage that when the artificial tooth 1 is being inserted into a receiving bed 2, the risk of cracks forming in the wax material of the receiving bed 2 in this region is reduced.

The artificial tooth 1 according to the invention in the state inserted into the receiving bed 2 is illustrated in FIG. 3. The receiving bed 2 is illustrated in section, to make the drawing easier to understand. The receiving bed 2 is saddle-shaped in cross section, so that it is held resting on the patient's alveolar ridge 3. It can be seen that in the inserted state the rim 14 on the underside of the artificial tooth 1 penetrates into the receiving bed 2. The wax material of the receiving bed 2 penetrates into the displacement space 13 and into the holding groove 15 until the holding groove 15 is virtually or completely full. The wax material which has penetrated into the holding groove 15 thereby secures the artificial tooth 1 with respect to movement in the buccal direction (to the left in the drawing) or in the opposite direction (to the right in the drawing). Furthermore, the holding groove 15 secures the artificial tooth 1 with respect to rotation about its vertical axis (running from the top to the bottom in the plane of the drawing). The holding groove 15 is preferably arranged vertically below the surface center of gravity of the top side 11, the direction of this vertical being defined by the direction of the mastication force A which is to be absorbed. As a result, the artificial tooth 1 according to the invention is substantially prevented from tilting sideways even under high mastication force loads. Consequently, the holding groove 15 according to the invention is reliably in engagement with the receiving bed 2 even under high loads and therefore secures the artificial tooth 1 according to the invention against undesired lateral displacements.

The effect of the holding groove 15 according to the invention will now be explained: if a mastication force A acts on the top side 11 of the artificial tooth 1, there is a risk that a horizontal force component will be produced at the underside 12 of the artificial tooth 1 on account of the effect of the skew plane B-B, this force component attempting to displace the artificial tooth in the buccal direction. The artificial tooth 1 is secured against this displacement by virtue of the holding groove 15 provided in accordance with the invention and the wax material of the receiving bed 2 which has penetrated into it. The artificial tooth could only be displaced if the artificial tooth 1 were to be lifted out of its seat illustrated in FIG. 3; however, the mastication force A applied in fact counteracts this. In this way, the artificial tooth 1 is automatically secured even under high loads.

Various steps involved in the production of an exemplary embodiment of the dental prosthesis according to the invention are illustrated in FIG. 1. FIG. 1a shows the wax prosthesis described above, having a receiving bed 2 made from wax material and artificial teeth 1 inserted therein. These artificial teeth are secured against undesirable displacement by means of their holding groove 15 arranged on the underside 12. This wax prosthesis is used to match the prosthesis to the patient. The artificial teeth 1 are correctly anatomically articulated in the receiving bed 2 at the end of this step. In the next step, which is illustrated in FIG. 1b, a negative mold is produced. This is done in such a way that the wax prosthesis is placed into a special vessel 9 containing a bed of molding material 8, so that the receiving bed 2 is supported by the molding material 8 over its entire underside. Furthermore, a duplicating medium 3, for example silicone, is introduced and molded in such a way that a wall extends around the outer rim of the wax prosthesis, embedding the artificial teeth 1. In this case, the wall touches only the outer side and the top side 11 of the artificial teeth. As a result, the artificial teeth 1 are unambiguously positioned in the duplicating medium 3, specifically in the anatomically correct position determined during the try-in. In a subsequent step, the wax material of the receiving bed 2 is then boiled out. As a result, a negative mold is produced from the duplicating medium 3 and the bed of molding material 8. Finally, in a subsequent step, fixing material 4 is introduced into this negative mold (cf. FIG. 1c). The underside 12 of the artificial teeth is immersed in the fixing material 4, with the result that the artificial teeth 1 are anchored in the fixing material 4. The outer sides and top sides 11 of the artificial teeth 1 are protected from being wetted by the fixing material 4 by the duplicating medium 3. During subsequent setting, the artificial teeth 1 are fixedly embedded in the correct position in the fixing material 4. This produces the final dental prosthesis, which then merely needs to be finish-machined. FIG. 1d illustrates how the process according to the invention is carried out if the artificial tooth 1 having the holding groove 15 according to the invention is an incisor. It is held on its outer side and incisally by the duplicating medium 3. The holding groove 15 according to the invention ensures that even the artificial tooth 1 as incisor, which is particularly susceptible to unintentional displacements, is reliably held in the receiving bed 2 of wax material used for try-in, so that anatomically correct positioning even in the fixing material 4 of the final dental prosthesis is achieved.

FIG. 4 shows a cross section through a second exemplary embodiment of the artificial tooth 1 according to the invention. It differs from the exemplary embodiment illustrated in FIG. 2 substantially by virtue of the fact that the exemplary embodiment illustrated in FIG. 3 is an anterior tooth. The text which follows will mainly deal with the differences between the two embodiments; the statements given above in connection with the first exemplary embodiment otherwise apply mutatis mutandis to the second exemplary embodiment. The main difference resides in the fact that in the second exemplary embodiment illustrated in FIG. 3, a cutting edge 11′ is provided instead of a top side 11 of areal extent. The arrangement of the holding groove 15 with respect to the cutting edge 11 is selected in such a way that the holding groove 15 is located approximately on the vertical of the cutting edge 11′, based on the mastication force A. This ensures that tilting of the artificial tooth 1 can be prevented even under a high mastication force A, so that the artificial tooth 1 is securely held in the receiving bed 2 by the holding groove 15 even under such high loads. It will be understood that where the explanations given in connection with the first exemplary embodiment referred to a buccal direction, what is meant in this exemplary embodiment is a labial direction.

1. An artificial tooth for dental prostheses having a top side designed as a biting surface and an underside configured for insertion of the underside of the artificial tooth into a receiving bed of the dental prosthesis, the underside having formed therein at least one holding groove which runs in a mesio-distal direction, relative to the artificial tooth.

2. The artificial tooth as claimed in claim 1, further comprising rounded portions provided in a region of transition between the holding groove and the underside.

3. The artificial tooth as claimed in claim 1 or 2, further comprising an encircling rim that forms a displacement space on the underside and in which the holding groove is formed.

4. The artificial tooth as claimed in claim 3, that wherein the holding groove is formed exclusively in the rim.

5. The artificial tooth as claimed in claim 1 or 2, wherein the holding groove is semicircular in cross section.

6. The artificial tooth as claimed in claim 1 or 2, wherein the holding groove is rectangular in cross section.

7. The artificial tooth as claimed in claim 1 or 2, further comprising at least one further holding groove parallel to the holding groove.

8. The artificial tooth as claimed in claim 1 or 2, wherein the holding groove is arranged vertically below a surface center of gravity of the top side, the direction of the vertical being defined by a mastication force imparted to the tooth in an implanted position.

9. A process for producing a dental prosthesis, comprising:
producing a wax prosthesis comprising artificial teeth which on their undersides have holding grooves running in a mesio-distal direction and a receiving bed that articulates the artificial teeth by inserting the artificial teeth into the receiving bed at the anatomically correct positions,
producing a negative mold of the wax prosthesis with a duplicating medium which is designed to receive the artificial teeth in such a way that they maintain their position,
removing the receiving bed,
introducing a fixing material into the negative mold, and
allowing the fixing material to set so that the underside undersides of the artificial teeth are permanently embedded in the fixing material.

10. The process as claimed in claim 9, wherein the artificial teeth further comprise rounded portions provided in regions of transition between the holding grooves and the undersides.

11. The process as claimed in claim 9, wherein each of the artificial teeth comprises a displacement space formed on the underside by an encircling rim in which the holding groove is formed.

12. The process as claimed in claim 11, wherein the holding groove is formed exclusively in the rim.

13. The artificial tooth as claimed in claim 3, wherein the holding groove is semicircular in cross section.

14. The artificial tooth as claimed in claim 3, wherein the holding groove is rectangular in cross section.

15. The artificial tooth as claimed in claim 3, further comprising at least one further holding groove parallel to the holding groove.

16. The artificial tooth as claimed in claim 3, wherein the holding groove is arranged vertically below a surface center of gravity of the top side, the direction of the vertical being defined by a mastication force imparted to the tooth in an implanted position.
